(19) United States
(12) Patent Application Publication
(10) Pub. No.: US 2005/0097306 A1
(43) Pub. Date: May 5, 2005

(54) No-instruction-set-computer processor

(76) Inventor: Daniel D. Gajski, Irvine, CA (US)

Correspondence Address: MYERS DAWES ANDRAS & SHERMAN LLP, Suite 1150, 19900 MacArthur Boulevard, Irvine, CA, 92612, US

(21) Appl. No.: 10/944,365

(22) Filed: Sep. 17, 2004

Related U.S. Application Data
(60) Provisional application No. 60/507,456, filed on Sep. 29, 2003.

(51) Int. Cl. G06F 9/00

(52) U.S. Cl. 712/245

(57) ABSTRACT

A no-instruction-set-computer (NISC) processor in combination with a program counter, program memory and data memory comprises a controller coupled to the program memory; and a datapath coupled to the controller and to the data memory, characterized in that computer code compiles directly into the controller and the datapath. The datapath comprises a plurality of storage elements, a plurality of functional units and a plurality of busses. The plurality of storage elements and functional units are selectively coupled together by the plurality of busses. The datapath collectively generate datapath output, and status signals and have a data memory input. The controller has no instruction set and computer code runs directly on the controller. The processor is combined with a compiler which is arranged and configured to operate a parse tree. Under control of the compiler the controller covers the parse tree with control words stored in the program memory.

### RELATED APPLICATIONS

The present application is related to U.S. Provisional Patent Application Ser. No. 60/507,456 filed on Sep. 29, 2003, which is incorporated herein by reference and to which priority is claimed pursuant to 35 USC 119.

### BACKGROUND OF THE INVENTION

1. Field of the Invention

The invention relates to the field of computer processors and in particular to the design of computer processor architectures as it relates to performance of such processors relative to instruction sets.

2. Description of the Prior Art

With complexities of systems-on-chip rising almost daily, the design community has been searching for new methodology that can handle given complexities with increased productivity and decreased time to market. The obvious solution is to increase the level of abstraction of the design, or in other words, increasing the size of the basic building blocks. However, it is not clear how many of these building blocks are needed and what these basic blocks. should be. Clearly, the necessary building blocks are processors and memories, however, the question remains: “Are they sufficient?”. How many types of processors and memories are really needed.

First, the complex-instruction-set computer (CISC) diagrammatically depicted in FIG. 1a was popular in 1970s. Since the program memory 12 was slow, designers tried to improve performance by constructing complex instructions. Each complex instruction took several clock cycles in program counter 8 with datapath control words for each clock cycle being stored in a much faster microprogram memory 14. The concept of microprogramming allowed for emulation of any instruction set and construction of specialized instructions, while speeding up the execution. Unfortunately, microprogramming did not allow for efficient pipe lining of the datapath 18 and data memory 24.

Then, reduced-instruction-set computer (RISC) diagrammatically depicted in FIG. 1b became popular in late 1980s by eliminating complex instructions and the microprogram memory. All instructions in a RISC are simple and execute in one clock cycle allowing datapath 18 to be efficiently pipelined in 4-8 pipelined stages. The microprogram memory was replaced with a decoding stage 20, that followed the instruction fetch from program memory stored in instruction register 22. Since instructions are simpler, a RISC needs approximately two instructions for each complex instruction and, therefore, the size of the program memory 12 is doubled. However, the fetch-decode-execute-store pipeline of the whole processor improved the execution speed several times over.

Pipelining or a pipeline is defined as a sequence of functional units (“stages”) which performs a task in several steps, like an assembly line in a factory. Each functional unit takes inputs and produces outputs which are stored in its output buffer. One stage's output buffer is the next stage's input buffer. This arrangement allows all the stages to work in parallel thus giving greater throughput than if each input had to pass through the whole pipeline before the next input could enter. The costs are greater latency and complexity due to the need to synchronize the stages in some way so that different inputs do not interfere. The pipeline will only work at full efficiency if it can be filled and emptied at the same rate that it can process. Pipelines may be synchronous or asynchronous. A synchronous pipeline has a master clock and each stage must complete its work within one cycle. The minimum clock period is thus determined by the slowest stage. An asynchronous pipeline requires handshaking between stages so that a new output is not written to the interstage buffer before the previous one has been used. Many CPUs are arranged as one or more pipelines, with different stages performing tasks such as fetch instruction, decode instruction, fetch arguments, arithmetic operations, store results. For maximum performance, these rely on a continuous stream of instructions fetched from sequential locations in memory. Pipelining is often combined with instruction prefetch in an attempt to keep the pipeline busy. When a branch is taken, the contents of early stages will contain instructions from locations after the branch which should not be executed. The pipeline then has to be flushed and reloaded. This is known as a pipeline break.

### BRIEF SUMMARY OF THE INVENTION

In order to introduce the concept of an NISC processor and its benefits, we first compare NISC features to the corresponding features of complex instruction set computer (CISC) and reduced instruction set computer (RISC) processors described above. Then, we will introduce the architecture of NISC controller and NISC datapath. In the second part of the disclosure we will demonstrate a simple methodology for design of the parametrizable and reconfigurable NISC processor and its compiler. We conclude with the advantages of NISC processor and its capability to unite software and hardware approaches in design and education.

The illustrated embodiment of the invention is thus a no-instruction-set-computer (NISC) processor in combination with a program counter, program memory and data memory comprising a controller coupled to the program memory; and a datapath coupled to the controller and to the data memory, characterized in that computer code compiles directly into the controller and the datapath.

The datapath comprises a plurality of storage elements, a plurality of functional units and a plurality of busses. The plurality of storage elements and functional units are selectively coupled together by the plurality of busses. The datapath collectively generate datapath output, and status signals and have a data memory input.

The plurality of storage elements and functional units are arranged and configured with each other over the plurality of busses to be pipelined, namely to be pipelined in a plurality of stages or each pipelined.

The controller defines the state of the processor and generates control signals communicated to and controlling the datapath. The controller generates a sequence of control words in order to execute a computation specified by a computer program stored in the program memory.

The may be implemented in gates and a state register according to a finite-state machine model. In such a hardware embodiment the controller has control inputs and outputs from an external environment and provides control signals to the external environment. The datapath generates status signals and control signals, which control signals are collectively defined as a “control word”. The controller receives the status signals from the datapath and provides the control word to the datapath. The controller is comprised of a state register, a next-state logic circuit and output logic circuit. The state register stores the present state of the processor, the next-state logic circuit for computing the next state to be loaded into the state register, and the output logic circuit for generating the control word and control outputs. The next-state and output logic circuits are combinatorial circuits implemented with logic gates. The state register and output logic circuit are redefinable and reconfigurable.

In another embodiment the controller comprises a program counter coupled to the program memory and an address generator coupled to the program counter and program memory. The address generator generates an address selected according to a function of the output control signals and status signals from the datapath coupled to the program memory so that the processor is computer programmable.

The datapath is reprogrammable by adding or omitting components in the datapath and is reconfigurable by reconnection components with the datapath into a different configuration.

The controller has no instruction set and where computer code runs directly on the controller. The controller converts legacy code into control words. The processor is combined with a compiler which is arranged and configured to operate a parse tree. Under control of the compiler the controller covers the parse tree with control words stored in the program memory. The controller is controlled by a compiler using high-level synthesis algorithms.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIGS. 1a and 1b are simplified block diagrams that depict prior art computer organizations, namely CISC and RISC.

FIG. 1c is a simplified block diagram illustrating the computer organization of the invention, NISC.

FIG. 2 is a block diagram showing one embodiment of the NISC datapath.

FIG. 3 is a block diagram showing one hardware embodiment of the NISC controller.

FIG. 4 is a block diagram showing one software embodiment of the NISC controller.

FIG. 5 is a block diagram showing one embodiment of the integration of a NISC controller and datapath.

FIG. 6 is a Y-chart illustrating various levels of modeling and abstraction of the design of an NISC computer system according to the invention.

FIG. 7 is a diagram illustrating a finite state machine with data (FSMD) which is then implemented into an NISC computer system according to the invention having a controller and datapath.

FIG. 8 is a Y-chart illustrating the design progression from a FSMD model to an NISC computer system according to the invention.

FIG. 9 is a Y-chart illustrating the back-end compilation from a FSMD model to an NISC computer system according to the invention.

FIG. 10 is a Y-chart illustrating the front-end compilation from a FSMD model to an NISC computer system according to the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

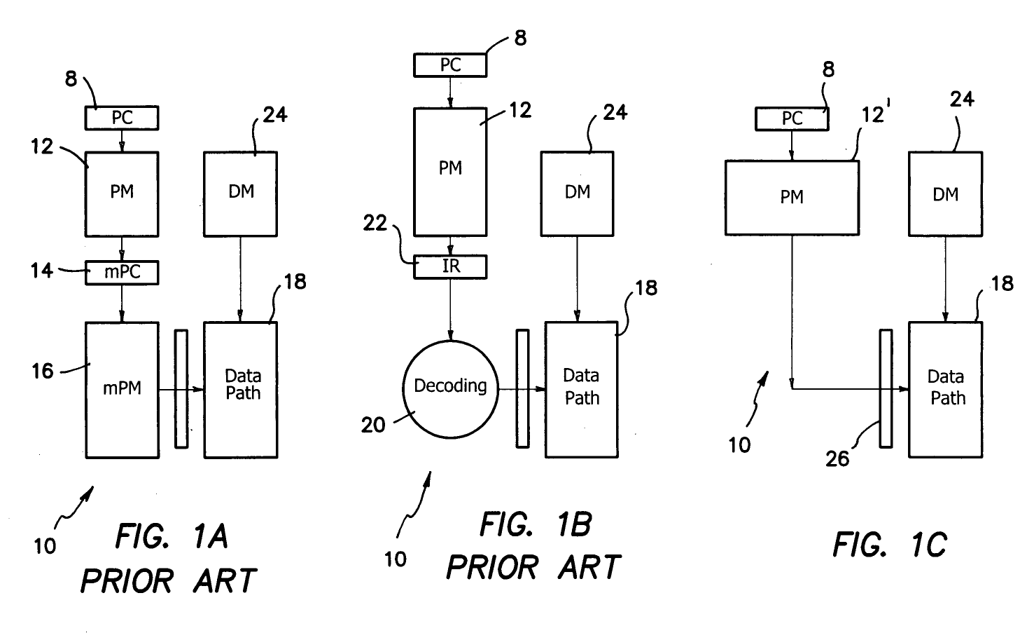

The invention is proposed as a no-instruction-set computer (NISC) as the single, necessary and sufficient processor component for design of any digital system. The no-instruction-set computer (NISC) of the invention diagrammatically depicted in FIG. 1c completely removes the decode stage 20 and stores the control word in the program memory 12′. Since control words are 2-3 times wider than instructions, the program memory 12′ is increased in width by 2-3 times. Fortunately, each control word can execute 2-3 RISC instructions. Therefore, NISC program memory 12′ is equivalent to RISC program memory 12. Furthermore each NISC is parametrizable and reconfigurable, which allows for very fine tuning to any application and performance.

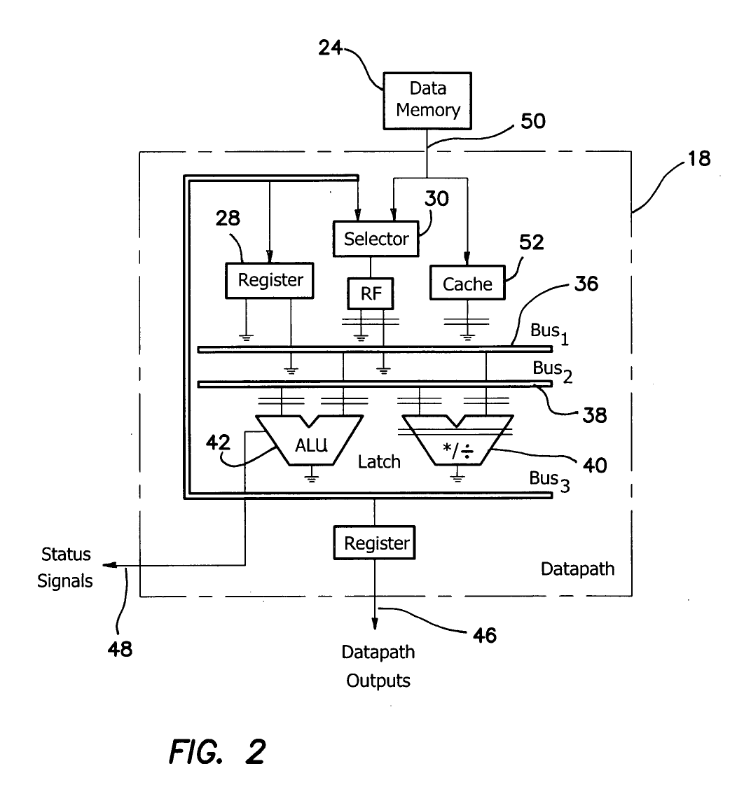

Consider now the NISC datapath 18 as shown in block diagram in FIG. 2. Any computer program can be executed on an NISC processor, which is comprised of a controller 26 and datapath 18. Datapath 18 is comprised of a set of storage elements, namely registers 28, 44, register files 34, and memories 32; a set of functional units, namely arithmetic logic units (ALUs) 42, multipliers 40, shifters 30, custom functions 30; and a set of busses 36, 38. All these components may be allocated in different numbers and types and arbitrarily connected with each other through busses 36, 38. The connections shown in FIG. 2 are illustrative only and the circuit or computer design can be organized in any manner now known or later devised consistent with the principles of the invention. Datapath 18 is only characterized as having a data input 50 from a data memory 24, a status signal output 48 and a datapath output 46. Each component may take one or more clock cycles to execute, each component may be pipelined according to conventional design principles and each component may have input or output latches or registers combined as part of the unit or its operation. The entire datapath 18 can be pipelined in several stages in addition to components being pipelined themselves. The controller 26 defines the state of the processor and issues the control signals for the datapath 18.

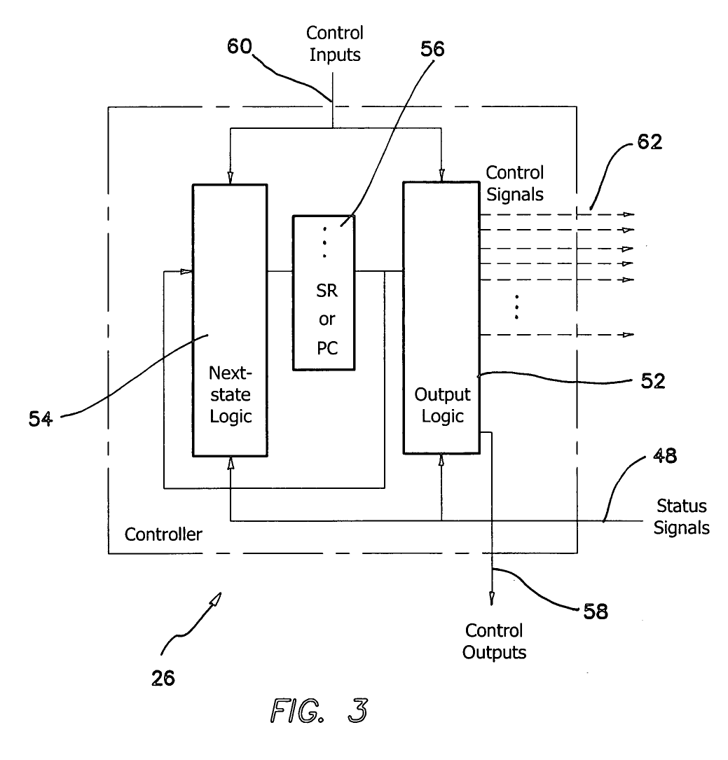

NISC controller 26 in the embodiment of a fixed implementation, such as in a hardware implementation, generates a sequence of control words in order to execute a computation specified by the computer program. If the sequence is short and it does not change over time, the controller 26 can be implemented with gates and a state register (SR) as diagrammatically depicted in FIG. 3. This implementation can be easily specified by a finite-state machine model (FSM).

The controller 26 has control inputs 60 and outputs 58 from the external environment and provides control signals 62 to the external environment. It also gets the status signals 48 from the datapath 18 and provides the control signals 62, collectively called “control word”, to the datapath 18. The controller 26 is comprised of a state register 56, a next-state logic circuit 54 and output logic circuit 52. State register 56 stores the present state of the processor which is equal to the present state of the FSM model describing the operation of the controller 26. The next-state logic circuit 54 computes the next state to be loaded into the state register 56, while the output logic circuit 52 generates the control signals 62 and the control outputs 58. The next-state and output logic circuits 54, 52 are combinatorial circuits implemented with logic gates. The state register 56 and output logic circuit 52 can be appropriately redefined and reconfigured from the architecture of FIG. 3 according to conventional design principles, if the controller 26 is implemented in a field programmable gate array (FPGA).

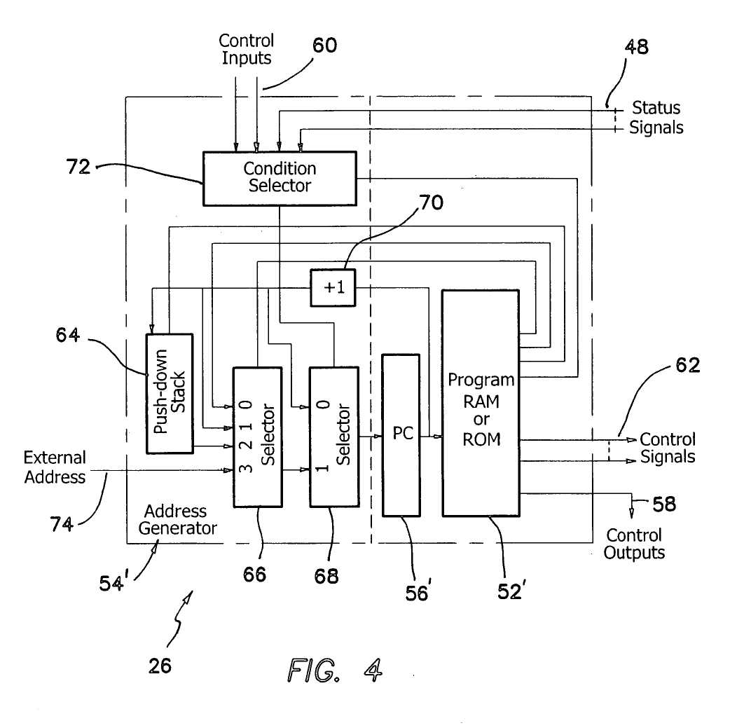

In the programmable embodiment of the NISC controller 26 as diagrammatically depicted by the example of FIG. 4, the state register 56 is replaced by a program counter (PC) 56′ while output logic circuit 52 is implemented by a program memory (PM) 52′. Program memory 52′ can be writable in a RAM or fixed in a ROM. The next-state logic circuit 54 is replaced by an address generator 54′, which computes the next program memory address from several sources. It can just increment the present address or generate a new address from a jump address in the program memory 52′, from external sources (OS) 74, or from the push-down stack (subroutine return) 64 having an input coupled to incrementer 70 and gated by programmable memory 52′. The proper address is selected by a mixture of output control signals 60 and status signals 48 from the datapath 18 using in combination condition selector 72 which is coupled to control inputs 60 and status signal 48 and is gated by programmable memory 52′, and selector 68 which has inputs coupled to selector 66 and incrementer 70 and is gated by condition selector 72. Selector 66 in turn has inputs coupled to external address 74, stack 64, programmable memory 52′ and incrementer 70, which is coupled to program counter 56′, and is gated by programmable memory 52′. Although the controller 26 shown in FIG. 4 is sufficient for any computation, it can be made more sophisticated while implementing the same functionality. For example, the program memory 52′ can include a cache (not shown) for speed up if a large program memory is required. However, the main characteristic of the programmable controller 26 is that new program can be loaded dynamically and executed, thus making the NISC computer programmable like any other processor.

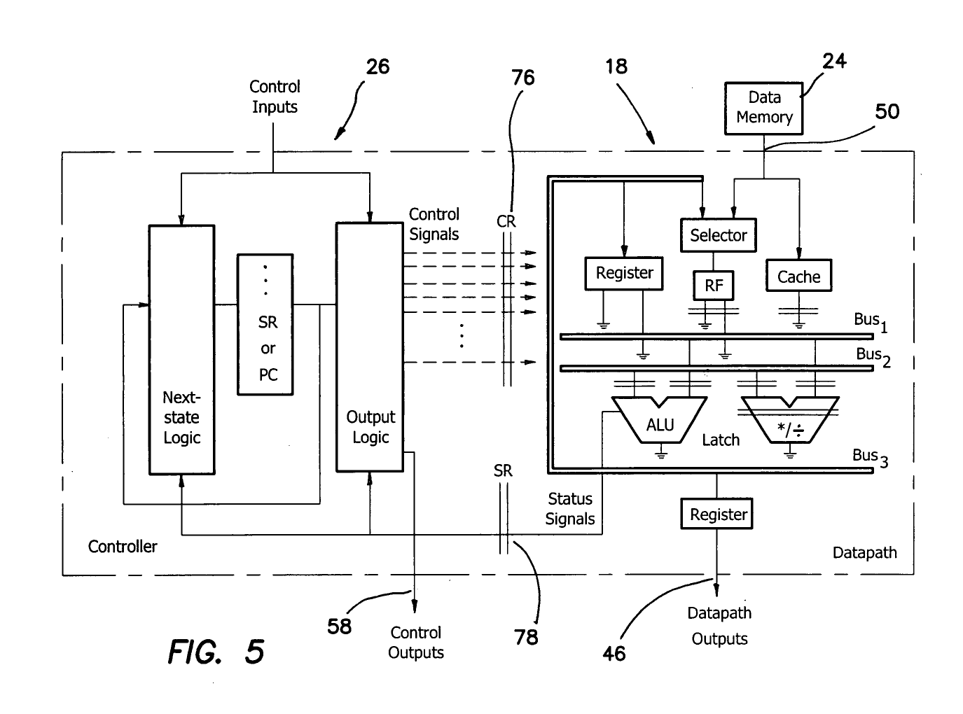

The NISC processor 10 is a combination of controller 26 and datapath 18 as diagrammatically depicted in FIG. 5, which illustrates one embodiment of a hardware implementation. Controller 26 may also be programmable as described above. Datapath 18 may be reprogrammable and reconfigurable as described above. Reprogrammable datapath 18 can be extended or reduced by adding or omitting some components, while reconfigurability means that datapath 18 can be reconnected with the same components. In either approach the original code must be recompiled. In order to speed up the NISC pipelining, a control register (CR) 76 and status register (SR) 78 is inserted between the controller 26 and the datapath 18.

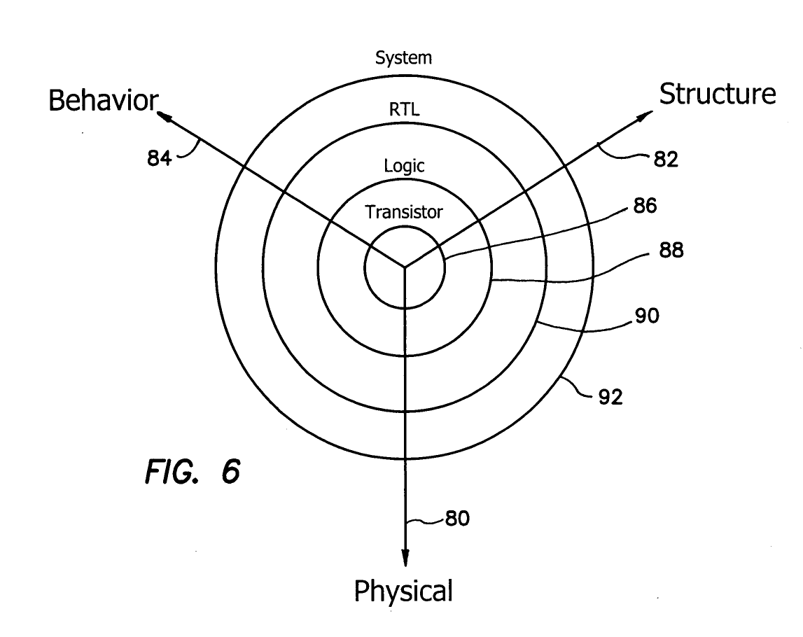

A Y-chart in FIG. 6 illustrates the relationship between different abstraction levels, design models and design methodologies or design flows for a NISC processor 10. The Y-chart makes the assumption that each design, no matter how complex, can be modeled in three basic ways emphasizing different properties of the same design. Therefore, Y-chart has three axes representing design behavior (function, specification) by axis 84, design structure (connected components, block diagram) by axis 82, and physical design (layout, boards, packages) by axis 80. Behavior represents a design as a black box and describes its outputs in terms of its inputs and time. The black-box behavior does not indicate in any way how to implement the black box or what its structure is. Implementation is given on the structure axis 82, where the black box is represented as a set of components and connections. Although, behavior of the black box can be derived from its component behaviors, such an obtained behavior may be difficult to understand. Physical design adds dimensionality to the structure by axis 80. It specifies size (height and width) of each component, the position of each component, each port and each connection on the silicon substrate or board or any other container.

The Y-chart of FIG. 6 can represents design on different abstraction levels identified by concentric circles around the origin. Usually, four levels are used: transistor level 86, logic level 88, register-transfers level 90 and system level 92. The name of the abstraction level is derived by the main component used in the structure on this abstraction level. Thus, the main components on transistor level 86 are N or P-type transistors, while on logic level 88 they are gates and flip-flops. On the register-transfers level 90 the main components are registers, register files and functional units such as ALUs, while on the system level 92 they are processors, memories and buses.

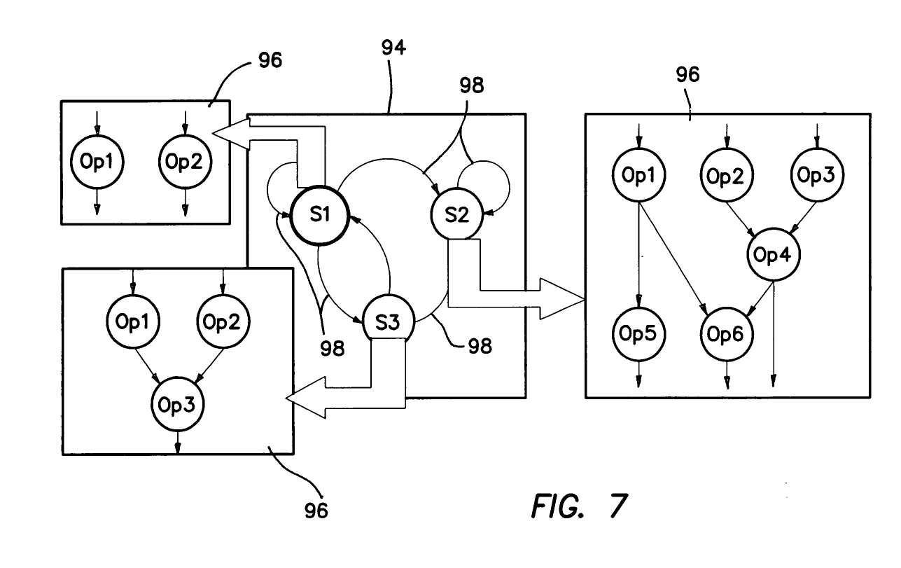

A register transfer language (RTL) behavior or computational model as diagrammatically depicted in FIG. 7 is given by a finite-state-machine with data (FSMD). It combines finite-state-machine (FSM) model for controller 26 and a data-flow-graph for datapath 18. FSM is defined by a set of states 94, e.g. S1-S3, and a set of transitions 98 from one state into other depending on the value of some of the input signals. In each state FSMD executes a set of expressions represented by a data-flaw-graph 96. The FSMD model is clock-accurate if each state takes a single clock-cycle.

It should be noted that FSMD model encapsulates the definition of the state-based (Moore-type) FSM in which the output is stable during duration of each state. It also encapsulates the definition of the input-based (Mealy-type) FSM with the following interpretation: Input-based FSM transitions to a new state and outputs data conditionally on the value of some of FSM inputs. Similarly, FSMD executes a set of expressions depending on the value of some FSMD inputs. However, if the inputs change just before the clock edge there may be not enough time to execute the expressions associated with that particular state. Therefore, designers should avoid this situation by making sure the input values change only early in the clock period or they must insert a state that waits for the input value change. In this case if the input changes too late in the clock cycle, FSMD will stay in the waiting state and proceed with a normal operation in the next clock cycle.

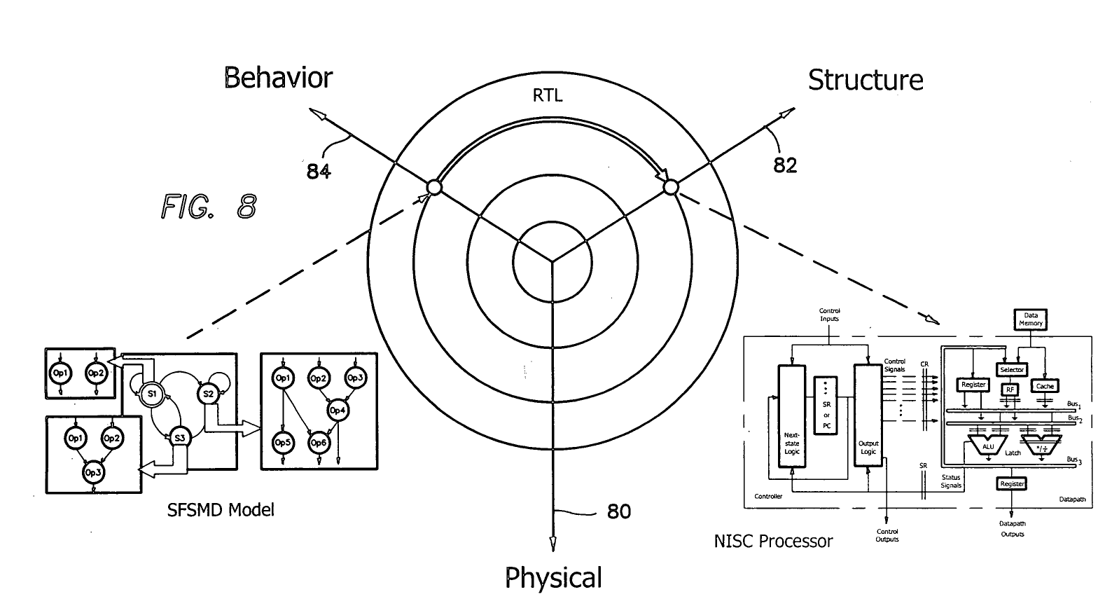

In one embodiment NISC design starts with the FSMD model on the behavior axes 84 of the Y-chart of FIG. 6 and ends up as depicted in FIG. 8 on axis 82 with a custom NISC processor 10 containing any number and type of components connected as required by the FSMD model. Note, that the FSMD model can be obtained easily from a programming language code such as C by grouping all the consecutive statements into basic blocks and introducing two states for each “if” statement or “loop” statement, where each state executes a basic block. Such a FSMD sometimes called super-state FSMD (SFSMD) since each basic block may be considered to be executed in one super state. This generation is very simple. Note that each basic block will be partitioned into several states during synthesis, where the number of states depends on the resources allocated to the NISC processor 10.

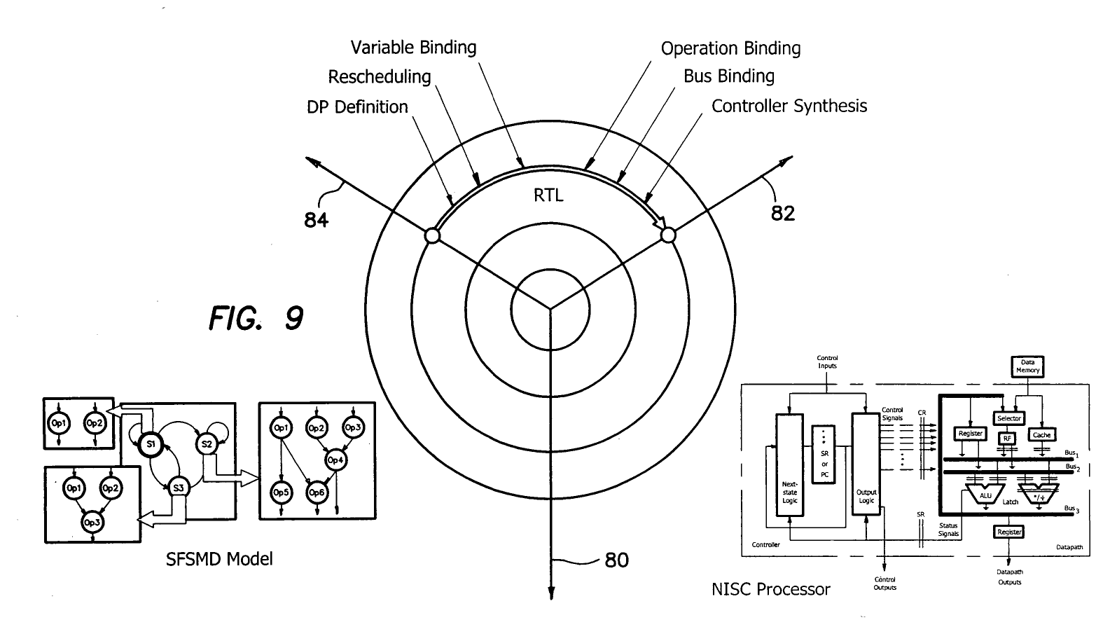

NISC backend compilation as depicted in the Y-chart of FIG. 9 is comprised of the datapath definition, generation of control-word sequence, and design of the controller (fixed or programmable), that executes the functionality specified by the FSMD model. It is comprised of several tasks:
1. Definition of the datapath 18 as a set of components and connections from the RTL library,
2. Binding of variables, operations and register transfers to storage elements, functional units and busses,
3. Rescheduling of computation in each state since some components may need more or less than one clock cycle, and computation must satisfy the datapath pipelining constraints.
4. Synthesis of a programmable or fixed controller.
5. Generation of control-word sequence for downloading to the controller RAM.

Any of the above tasks can be performed manually or automatically.

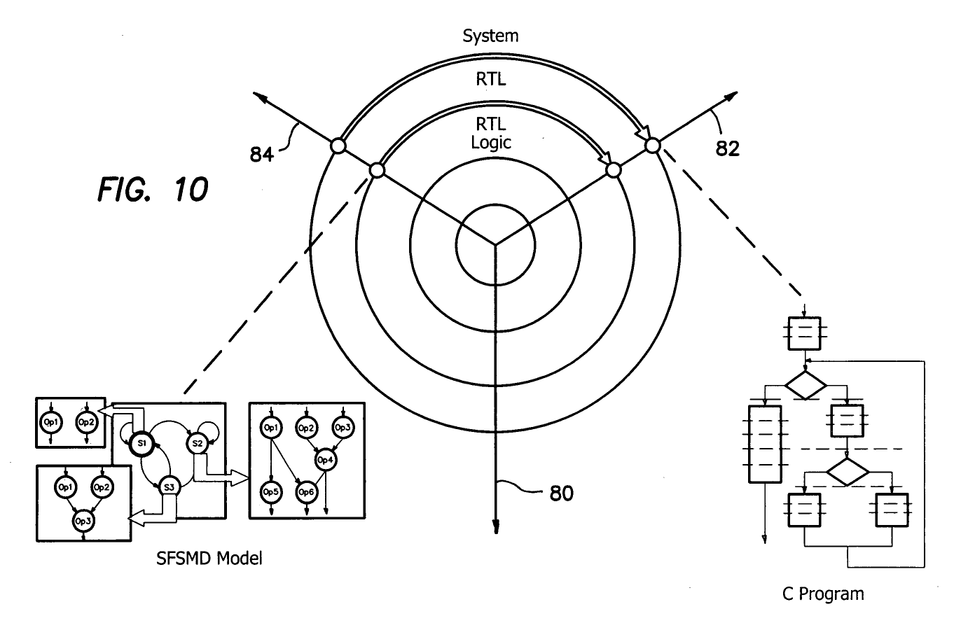

The front-end NISC processor definition and compilation follows the task of system design, in which the components and their connectivity as well as partitioning or mapping of system functionality onto different components is performed as diagrammatically depicted in the Y-chart of FIG. 10. Therefore, for each NISC component in the system, the computer code that executes on that component is known.

NISC compilation is comprised of parsing that computer code and constructing from the parse tree the well known control-data flow graph. The control-data flow graph is comprised of three objects: “if” statements, “loop” statements, and basic blocks of assignment statements without “ifs” or “loops”. Each “if” and “loop” statement needs two states in the FSMD while basic blocks can be executed in one or more states depending on the availability of resources in the datapath 18. Such a control-data flow graph is equivalent to the super state FSMD (SFSMD) which is the starting point for the NISC back-end of FIG. 9.

The NISC processor 10 is the single, necessary and sufficient computation component for design of systems-on-chip with memory the other necessary and sufficient storage component. The NISC processor design can thus be thought of as a set of components with different datapaths 18 and controllers 26 and one compiler. NISC unifies several concepts from processor architecture, compilers and high-level synthesis into one concept. Therefore, it simplifies design, education, CAD, testing, IP trade and other aspects of traditional design. The NISC processor can be reconfigured and reprogrammed statically and dynamically to satisfy power, performance, cost, reliability and other constraints. Such programmability allows a NISC processor to emulate other instruction sets. Since the instruction set is eliminated the computer code compiles directly into hardware. There is no unnecessary interpretation between computer code and hardware, that allows a NISC processor to execute any code as fast as semiconductor technology will allow it. In other words, NISC is the fastest implementation of any computer program.

The NISC benefits can now be appreciated to include:
1. Equivalency between hardware and software implementation of the design with fastest possible execution by datapath parallelism or pipelining. For a hardware implementation the control words are in ROM or gate logic, while for a software implementation they are in a RAM. Since the data processor can be pipelined by introducing any number of stages and since the data processor can have any level of parallelism, it is difficult to outperform NISC.
2. No unnecessary interpretation since there is no instruction set, no decoding logic since there is no instruction register, and execution of any instruction set and execution of any legacy code given the appropriate data processor. Since there is no instruction set, an NISC processor eliminates the last stage of interpretation between computer code and hardware or the data processor, which computer code runs directly on hardware or the data processor. NISC can emulate any instruction set, since NISC control word can execute any operation as long as the data processor resources are available. Therefore, any legacy code can be executed on a properly defined NISC processor by converting legacy instructions into NISC control words through a table look up.¹
   ¹Legacy code is source code that relates to a no-longer supported or manufactured operating system. The term can also mean code inserted into modern software for the purpose of maintaining an older or previously supported feature, for example supporting a serial interface even though most modern systems only have USB. In practice, most source code has some dependency on the system on which it is designed for. When the manufacturer upgrades or supersedes that system, the code will no longer work without changes, and becomes legacy code. A large part of the task of a software engineer is altering code to continually prevent this. While the term usually refers to source code, it can occasionally be heard applied to executable code that no longer runs on a modern version of a system, or requires a compatible environment to do so.
3. More complex compiler can be used with high-level synthesis matching. The NISC compiler uses high-level synthesis algorithms for covering the parse tree with control words. Since an NISC processor is a sufficient component for any computation, only one compiler is needed worldwide which can be made available in the public domain.
4. Only one compiler worldwide and only one processor worldwide albeit with different parameters. Similarly, only one NISC processor, although in different versions and with different parameters, is needed worldwide. That uniqueness will simplify education, design, trade, maintenance, testing and many other aspects of system design, in similar fashion as gate libraries led to standardization of digital design.

Many alterations and modifications may be made by those having ordinary skill in the art without departing from the spirit and scope of the invention. For example,

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

1. A no-instruction-set-computer (NISC) processor in combination with a program counter, program memory and data memory comprising:
a controller coupled to the program memory; and
a datapath coupled to the controller and to the data memory, characterized in that computer code compiles directly into the controller and the datapath.

2. The processor of claim 1 where the datapath comprises a plurality of storage elements, a plurality of functional units and a plurality of busses, the plurality of storage elements and functional units being selectively coupled together by the plurality of busses, the datapath collectively generating datapath output, and status signals and having a data memory input.

3. The processor of claim 1 where the plurality of storage elements and functional units are arranged and configured with each other over the plurality of busses to be pipelined.

4. The processor of claim 3 where the plurality of storage elements and functional units are arranged and configured with each other over the plurality of busses to be pipelined in a plurality of stages.

5. The processor of claim 3 where the plurality of storage elements are each pipelined and functional units are each pipelined.

6. The processor of claim 4 where the plurality of storage elements are each pipelined and functional units are each pipelined.

7. The processor of claim 1 where the controller defines the state of the processor and generates control signals communicated to and controlling the datapath.

8. The processor of claim 7 where the controller generates a sequence of control words in order to execute a computation specified by a computer program stored in the program memory.

9. The processor of claim 8 where the controller is implemented in gates and a state register according to a finite-state machine model.

10. The processor of claim 1 where the controller has control inputs and outputs from an external environment and provides control signals to the external environment, where the datapath generates status signals and control signals, which control signals are collectively defined as a “control word”, where the controller receives the status signals from the datapath and provides the control word to the datapath.

11. The processor of claim 10 where controller is comprised of a state register, a next-state logic circuit and output logic circuit, the state register for storing the present state of the processor, the next-state logic circuit for computing the next state to be loaded into the state register, and the output logic circuit for generating the control word and control outputs.

12. The processor of claim 11 where the next-state and output logic circuits are combinatorial circuits implemented with logic gates, where the state register and output logic circuit redefinable and reconfigurable.

13. The processor of claim 1 where controller comprises a program counter coupled to the program memory and an address generator coupled to the program counter and program memory.

14. The processor of claim 13 where address generator generates an address selected according to a function of the output control signals and status signals from the datapath coupled to the program memory so that the processor is computer programmable.

15. The processor of claim 1 where the datapath is reprogrammable by adding or omitting components in the datapath.

16. The processor of claim 1 where the datapath is reconfigurable by reconnection components with the datapath into a different configuration.

17. The processor of claim 1 where the controller has no instruction set and where computer code runs directly on the controller.

18. The processor of claim 8 where the controller converts legacy code into control words.

19. The processor of claim 8 in further combination with a compiler which is arranged and configured to operate a parse tree and wherein the controller under control of the compiler covers the parse tree with control words stored in the program memory.

20. The processor of claim 19 where the controller is controlled by a compiler using high-level synthesis algorithms.
